(19) United States
(12) Patent Application Publication
(10) Pub. No.: US 2017/0019459 A1
(43) Pub. Date: Jan. 19, 2017

(54) FILE TRANSMISSION METHOD, FILE TRANSMISSION APPARATUS, AND FILE TRANSMISSION SYSTEM

(71) Applicant: TENCENT TECHNOLOGY (SHENZHEN) COMPANY LIMITED, Shenzhen (CN)

(72) Inventors: Xiaodong OU, Shenzhen (CN); Jiubiao CHEN, Shenzhen (CN)

(73) Assignee: TENCENT TECHNOLOGY (SHENZHEN) COMPANY LIMITED, Shenzhen (CN)

(21) Appl. No.: 15/277,858

(22) Filed: Sep. 27, 2016

Related U.S. Application Data
(63) Continuation of application No. PCT/CN2015/082380, filed on Jun. 25, 2015.

(30) Foreign Application Priority Data
Jun. 30, 2014 (CN) 201410306522.4

(51) Int. Cl. H04L 29/08; H04W 8/00; H04L 1/16; H04W 4/00

(52) U.S. Cl. CPC H04L 67/06; H04W 4/008; H04W 8/005; H04L 1/16

(57) ABSTRACT

A file transmission method, a file transmission apparatus, and a file transmission system are described. The method includes: receiving a file transmission request from an application, where the file transmission request includes a position and a filename of a to-be-transmitted file; establishing, in response to receiving the file transmission request, a wireless access point; searching for at least one connectable client by using the wireless access point; displaying the at least one connectable client in a form of a list; receiving a selection instruction for a connectable client in the list; and establishing a connection to the connectable client corresponding to the selection instruction and sending the to-be-transmitted file having the filename and at the position to the selected connectable client.

### CROSS REFERENCE

This application is a continuation application of International Application No. PCT/CN2015/082380, titled “FILE TRANSMISSION METHOD, FILE TRANSMISSION APPARATUS, AND FILE TRANSMISSION SYSTEM”, filed on Jun. 25, 2015, which claims priority to Chinese Patent Application No. 201410306522.4, filed on Jun. 30, 2014, which are hereby incorporated by reference in their entirety.

### FIELD OF THE TECHNOLOGY

The present disclosure relates to the field of electronic devices, such as mobile terminals, and in particular, to a file transmission method, a file transmission apparatus, and a file transmission system.

### BACKGROUND OF THE DISCLOSURE

With the development of the society, science, and technology, more and more people use mobile terminals and people have more and more requirements on functions of the mobile terminals. For example, people not only hope to implement network interaction and information acquisition functions by using the mobile terminals, but also hope to implement functions, such as short-distance file transmission, by using the mobile terminals.

People usually perform short-distance file transmission by using mobile terminals through an external network or Bluetooth. A transmission speed of performing short-distance file transmission by using an external network is greatly limited by the external network and the short-distance file transmission possibly needs to consume traffic of a mobile terminal. Although short-distance file transmission performed in a manner such as Bluetooth does not consume traffic of the mobile terminal, a transmission speed is low and file transmission efficiency is affected.

### SUMMARY

Embodiments of the present invention provide a file transmission method, apparatus, and system that have a high transmission speed and high transmission efficiency and are not limited by an external network.

An embodiment of the present invention provides a file transmission method, applied to an electronic device, which comprises a memory, at least one processor in communication with the memory, and program instructions stored in the memory and executed by the at least one processor, the method including:

receiving by the electronic device a file transmission request from an application, the file transmission request including a position and a filename of a to-be-transmitted file from the application;

establishing by the electronic device, in response to receiving the file transmission request, a wireless access point;

searching by the electronic device for at least one connectable client by using the wireless access point;

displaying the at least one connectable client in a form of a list;

receiving by the electronic device a selection instruction for a connectable client in the list; and

establishing by the electronic device a connection to the connectable client corresponding to the selection instruction and sending the to-be-transmitted file having the filename and at the position to the selected connectable client.

An embodiment of the present invention further provides a file transmission apparatus, comprising:

a memory containing program instructions; and

at least one processor, in communication with the memory, when executing the program instructions, is configured to cause the apparatus to:

receive a file transmission request from an application, the file transmission request comprising a position and a filename of a to-be-transmitted file;

establish, in response to receiving the file transmission request, a wireless access point;

search for at least one connectable client by using the wireless access point and display the at least one connectable client in a form of a list; and

receive a selection instruction for a connectable client in the list, establish a connection to the connectable client corresponding to the selection instruction, and send the to-be-transmitted file having the filename and at the position to the selected connectable client.

An embodiment of the present invention further provides a file transmission system, comprising:

a first file transmission apparatus, comprising:

a first memory containing a first set of program instructions;

at least one first processor, in communication with the first memory, when executing the first set of program instructions, is configured to cause the first apparatus to:

receive a sharing instruction and generate, in response to receiving the sharing instruction, a file transmission request comprising a position and a filename of a to-be-transmitted file; and

receive a transmission application selection instruction and determine a transmission application according to the transmission application selection instruction; and a second file transmission apparatus, comprising:

a second memory containing a second set of program instructions;

at least one second processor, in communication with the second memory, when executing the second set of program instructions, is configured to cause the second apparatus to:

receive the file transmission request from the first apparatus;

establish, in response to receiving the file transmission request, a wireless access point;

search for at least one connectable client by using the wireless access point and display the at least one connectable client in a form of a list; and

receive a selection instruction for a connectable client in the list, establish a connection to the connectable client corresponding to the selection instruction, and send the to-be-transmitted file having the filename and at the position to the selected connectable client.

In the file transmission method, file transmission apparatus, and file transmission system in the embodiments of the present invention, an access point for wireless access is automatically established by using a transmission application and the access point for wireless access is automatically used to perform file transmission, thereby solving a technical problem that file transmission is greatly limited by an external network or has a low transmission speed.

### BRIEF DESCRIPTION OF THE DRAWINGS

FIG. 1 illustrates a flowchart of a file transmission method of some embodiments of the present disclosure;

FIG. 2 illustrates a detailed flowchart of step S104 in FIG. 1;

FIG. 3 illustrates a flowchart of a file transmission method of some embodiments of the present disclosure;

FIG. 4 illustrates a schematic structural diagram of a file transmission apparatus of some embodiments of the present disclosure;

FIG. 5 illustrates a schematic structural diagram of a transmission module of some embodiments of the present disclosure;

FIG. 6 illustrates a schematic structural diagram of a file transmission system of some embodiments of the present disclosure; and

FIG. 7 illustrates a working flowchart of a file transmission system in some embodiments of the present disclosure.

### DESCRIPTION OF EMBODIMENTS

Referring to the drawings, same component symbols represent same components. A principle of the present disclosure is described by using examples in which the present disclosure is implemented in proper computing environments. The following descriptions are specific embodiments of the present disclosure based on the examples, and should not be construed as a limitation to other specific embodiments of the present invention that are not described herein in detail.

In the description below, the specific embodiments of the present invention will be described with reference to steps and signs of operations that are performed by at least one computer, unless indicated otherwise. Therefore, it will be understood that such steps and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by persons skilled in the art. The data structures in which data is maintained are physical locations of the memory that have particular properties defined by the format of the data. However, while the principle of the present disclosure is being described in the foregoing text, it is not meant to be limiting as persons skilled in the art will appreciate that the various steps and operations described hereinafter may also be implemented in hardware.

The terms, such as “component”, “module”, “system”, “interface”, and “process”, used in the present disclosure generally indicate relevant entities of a computer, including hardware, a combination of hardware and software, software, or software in execution. For example, a component may be, but not limited to, a process running on a processor, a processor, an object, an executable application, an executed thread, a program, and/or a computer. With reference to the drawings, an application running on a controller and the controller may both be components. One or more components may be in an executed process and/or thread and the components may be located on one computer and/or distributed between or among two or more computers.

Moreover, the subject required to be protected may be implemented by using standard programming and/or an engineering technology to produce software, firmware, hardware, or any other combination thereof, to control a computer to implement a method, an apparatus, or an article of manufacture of the disclosed subject. The term “article of manufacture” used in the specification is intended to include a computer program accessible from any computer-readable device, carrier, or medium. Certainly, persons skilled in the art may be aware that modifications may be performed on the configuration without departing from the scope and spirit of the subject required to be protected.

The specification provides various operations of embodiments. In an embodiment, the one or more operations may constitute one or more computer-readable instructions stored in a computer-readable medium, and when executed by an electronic device, the computer-readable instructions enable a computing device to perform the operations. Describing a sequence of some or all operations shall not be interpreted as implying that the operations must be sequentially related. Persons skilled in the art will understand an alternative sequence having the benefits of the specification. Moreover, it should be understood that not all operations are mandatory in each embodiment provided in the specification.

Moreover, the word “preferably” used in the specification refers to an instance, an example, or an illustration. Any aspect or design described as “preferred” in the specification is not necessarily interpreted as advantageous over other aspects or designs. Rather, the word “preferred” is used to put forward a concept in a specific manner. The term “or” used in this application is intended to mean an inclusive “or” rather than an exclusive “or”. That is, unless specified otherwise or clear from the context, “X uses A or B” refers to any of natural inclusive permutations. That is, if X uses A, X uses B, or X uses both A and B, “X uses A or B” is satisfied in any one of the foregoing examples.

Furthermore, although the present disclosure is shown and described by using one or more implementation manners, persons skilled in the art may conceive of equivalent variations and modifications based on reading and understanding of the specification and the accompany drawings. The present disclosure includes all such variations and modifications, which is only limited by the scope of the appended claims. In particular regard to the various functions performed by the foregoing components (such as elements and resources), terms used to describe such components are intended to correspond to any component (unless indicated otherwise) performing specified functions of the components (for example, the components are equivalent in functions), even though structures of the functions are not equivalent to the disclosed structures of functions in the exemplary implementation manners in the specification shown in the specification. In addition, although specific features of the specification are disclosed with respect to only one of several implementation manners, the features may be combined with one or more other features of other implementation manners that are desirable for and advantageous to a given or specific application. Moreover, for the terms “include”, “have”, “contain” or variations thereof being used in specific implementation manners or claims, the terms are intended to be inclusive in a similar manner to that of the term “comprise”.

A file transmission method according to embodiments of the present invention may be implemented by using various electronic devices, that is, file transmission between at least two electronic devices can be implemented conveniently. An electronic device herein includes, but is not limited to, a mobile terminal, a personal digital assistant, a tablet computer, or a mobile media player. The file transmission method of the present disclosure may be stored in an electronic device in a form of a “computer-readable instruction” and executed by one or more processors in the electronic device, so as to implement the file transmission method. The computer-readable instruction may be distributed by a computer-readable medium. The computer readable instruction may be implemented as a program module, for example, a function, an object, an application programming interface (API), or a data structure for executing a specific task or implementing a specific abstract data type. Typically, functions of the computer readable instruction may be randomly combined or distributed in various environments.

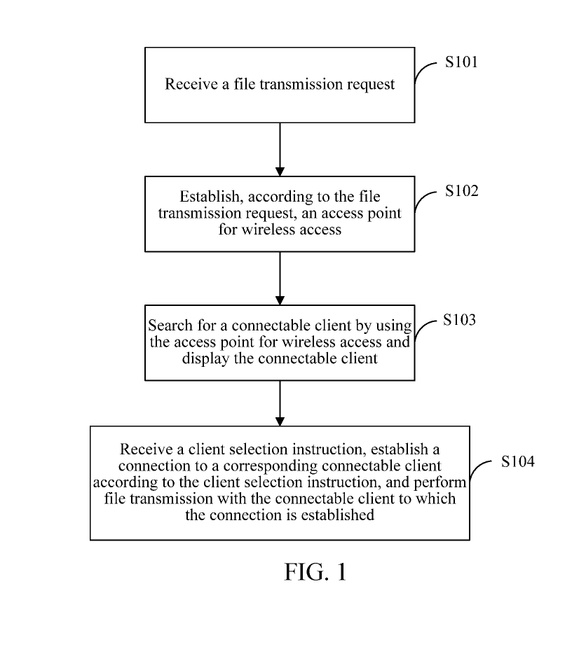

Referring to FIG. 1, FIG. 1 illustrates a flowchart of a file transmission method of some embodiments of the present disclosure. The file transmission method of this preferred embodiment may be implemented by using the foregoing electronic device and includes:

Step S101: Receive a file transmission request of an application.

Step S102: Establish, in response to receiving the file transmission request, an access point for wireless access.

Step S103: Search for a connectable client by using the access point for wireless access and display the connectable client.

Step S104: Receive a client selection instruction, connect to a corresponding connectable client according to the client selection instruction, and send a to-be-transmitted file.

Detailed processes of the steps of the file transmission method of this preferred embodiment are described below in detail.

In step S101, a file transmission apparatus, for example, an electronic device, receives a file transmission request of a third-party application, where the file transmission request includes a position (or location) and a name of a to-be-transmitted file. The third-party application herein is an application incapable of providing a short-distance file transmission function, and at the same time, the third-party application is capable of invoking a sharing interface of an electronic device (for example, a mobile terminal) to send a file transmission request to another application (for example, a transmission application having a short-distance file transmission function) through the sharing interface. The file transmission request may be a request for sending a to-be-transmitted file at a specific position and having a specific name to another mobile terminal or client. Therefore, the file transmission request should include the position and the filename of the to-be-transmitted file. Subsequently, step S102 is performed.

In step S102, the file transmission apparatus (or a transmission application in the mobile terminal) establishes, in response to receiving the file transmission request, an access point for wireless access. The access point for wireless access, that is, a wireless access point, is equivalent to a bridge for connecting different wireless network clients, and file transmission between different network clients can be implemented by using the access point for wireless access. A network client herein may be a mobile terminal connected to the access point for wireless access or may be a mobile terminal establishing the access point for wireless access. Subsequently, step S103 is performed.

In step S103, the file transmission apparatus searches for a connectable client (network client) by using the access point for wireless access and displays the connectable client. In order to implement short-distance transmission between different network clients, the file transmission apparatus searches for a connectable network client by using the access point for wireless access, where the network client herein should have a wireless network (for example, WiFi) enabled, to ensure that the file transmission apparatus can find a network client to which the file needs to be transmitted. After finding all connectable clients, the file transmission apparatus displays all of the found connectable clients in a list, that is, displays the connectable clients in a form of a list, so that a user makes a selection conveniently. Subsequently, step S104 is performed.

In step S104, the file transmission apparatus receives a selection instruction for a client in the list, where the client selection instruction is an instruction sent by a user for selecting a connectable client. By receiving the selection instruction, the file transmission apparatus connects to the selected connectable client, and sends the to-be-submitted file to the connectable client after the connection.

Preferably, when the file transmission apparatus (that is, the transmission application) is set in a mobile terminal, the file transmission apparatus registers an action value in a system file of the mobile terminal to invoke a sharing interface of the mobile terminal, where code of the action value is:

<action android:name=“android.intent.action.SEND”/>; and

the file transmission apparatus may receive file transmission requests of different applications by invoking the sharing interface of the mobile terminal.

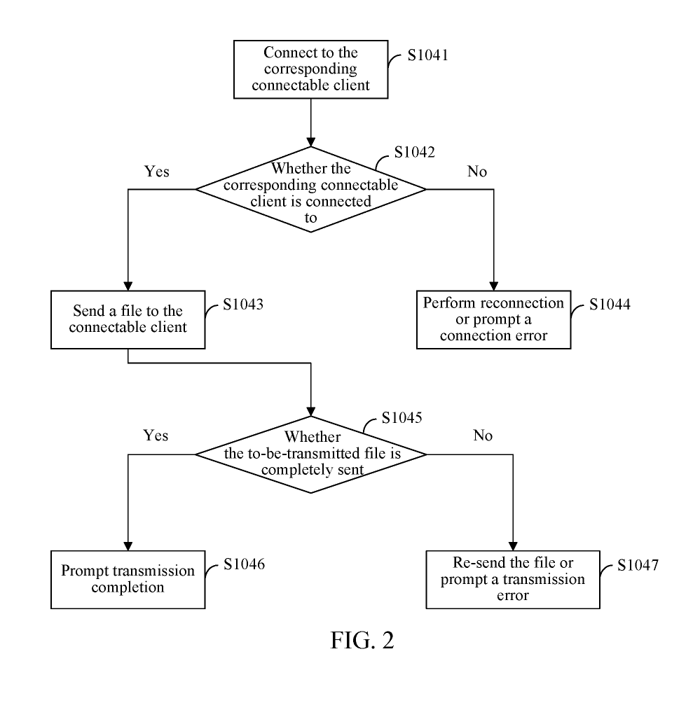

Preferably, referring to FIG. 2, FIG. 2 illustrates a detailed flowchart of step S104 in FIG. 1. The step S104 may include:

Step S1041: The file transmission apparatus connects to the connectable client corresponding to the selection instruction, and subsequently, step S1042 is performed.

Step S1042: Determine whether the connectable client corresponding to the selection instruction is connected. Step S1043 is performed if the connectable client corresponding to the selection instruction is connected. Step S1044 is performed if the connectable client corresponding to the selection instruction is not connected.

Step S1043: The file transmission apparatus sends the to-be-submitted file having the filename and at the position to the connectable client, and subsequently, step S1045 is performed.

Step S1044: The file transmission apparatus reconnects to the connectable client or prompts a connection error.

Step S1045: Determine whether the to-be-transmitted file is completely sent.

Step S1046 is performed if the to-be-transmitted file is completely sent. Step S1047 is performed if sending of the to-be-transmitted file is interrupted.

Step S1046: The file transmission apparatus prompts transmission completion.

Step S1047: The file transmission apparatus re-sends the to-be-transmitted file or prompts a transmission error.

In the file transmission method of this preferred embodiment, an access point for wireless access is automatically established by using a transmission application and the access point for wireless access is automatically used to perform file transmission, so that a transmission process is not limited by an external network and has a high transmission speed.

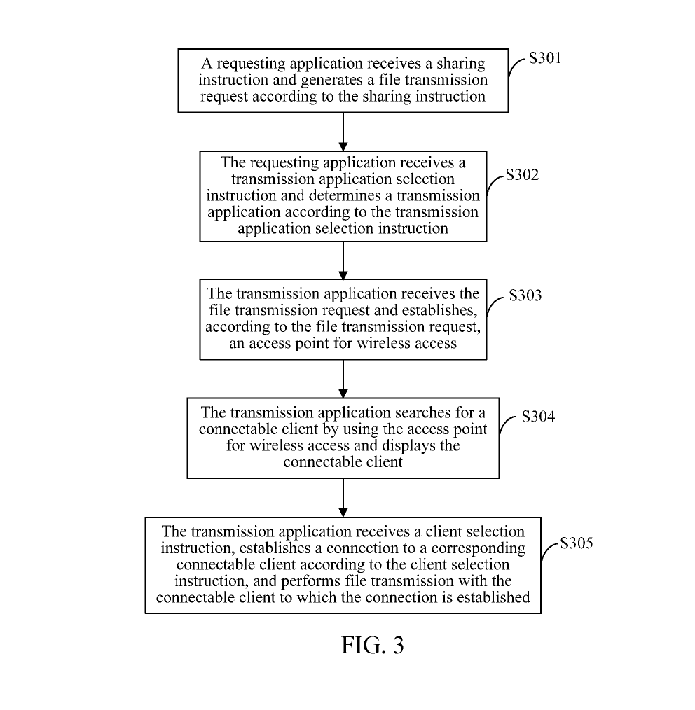

Referring to FIG. 3, FIG. 3 illustrates a flowchart of a file transmission method of some embodiments of the present disclosure. The file transmission method of this preferred embodiment may be implemented by using the foregoing electronic device and includes:

Step S301: A requesting application receives a sharing instruction and generates a file transmission request according to the sharing instruction.

Step S302: The requesting application receives a transmission application selection instruction and determines a transmission application according to the transmission application selection instruction.

Step S303: The transmission application receives the file transmission request and establishes, in response to receiving the file transmission request, an access point for wireless access.

Step S304: The transmission application searches for a connectable client by using the access point for wireless access and displays the connectable client.

Step S305: The transmission application receives a client selection instruction, connects to a corresponding connectable client according to the client selection instruction, and sends a file.

The file transmission method of this preferred embodiment ends with step S305.

Detailed processes of the steps of the file transmission method of this preferred embodiment are described below in detail.

In step S301, a third-party application (that is, a requesting application) in a mobile terminal receives a sharing instruction input by a user and generates a file transmission request according to the sharing instruction, where the sharing instruction is an instruction of requesting file transmission by the user. The file transmission request includes a position and a filename of a to-be-transmitted file. The requesting application is an application incapable of providing a short-distance file transmission function and capable of invoking a sharing interface of the mobile terminal. Subsequently, step S302 is performed.

In step S302, the requesting application invokes the sharing interface of the mobile terminal, and the requesting application may obtain at least one transmission application (the transmission application has a short-distance file transmission function) through the sharing interface of the mobile terminal. Subsequently, the requesting application receives a transmission application selection instruction and determines, according to the transmission application selection instruction, a transmission application for transmitting the file. The transmission application selection instruction is an instruction of selecting a transmission application by the user, for example, if the sharing interface of the mobile terminal provides three transmission applications, that is, “sharing by using WeChat (WeChat), sharing by using QQ (QQ), and sharing by using Mobile Manager (Mobile Manager)”, the user may select Mobile Manager as the transmission application. Subsequently, step S303 is performed.

Step S303 is the same as or similar to descriptions in step S101 and S102 in the FIG. 1, and they are both about how the transmission application performs file transmission. Reference may be made to the relevant descriptions in step S101 and step S102 in FIG. 1 for details.

Step S304 is the same as or similar to the description in step S103 in FIG. 1. Reference may be made to the relevant description in step S103 in FIG. 1 for details.

Step S305 is the same as or similar to the description in step S104 in FIG. 1. Reference may be made to the relevant description in step S104 in FIG. 1.

Preferably, when the transmission application is set in a mobile terminal, the transmission application registers an action value in a system file of the mobile terminal to invoke a sharing interface of the mobile terminal, where code of the action value is:

<action android:name=“android.intent.action.SEND”/>; and

the transmission application may receive file transmission requests of different requesting applications by invoking the sharing interface of the mobile terminal.

In the file transmission method of this preferred embodiment, a requesting application of a mobile terminal can invoke a transmission application through a sharing interface of the mobile terminal to automatically establish an access point for wireless access, and the transmission application can automatically use the access point for wireless access to perform file transmission, so that a transmission process is not limited by an external network and thus has a high transmission speed.

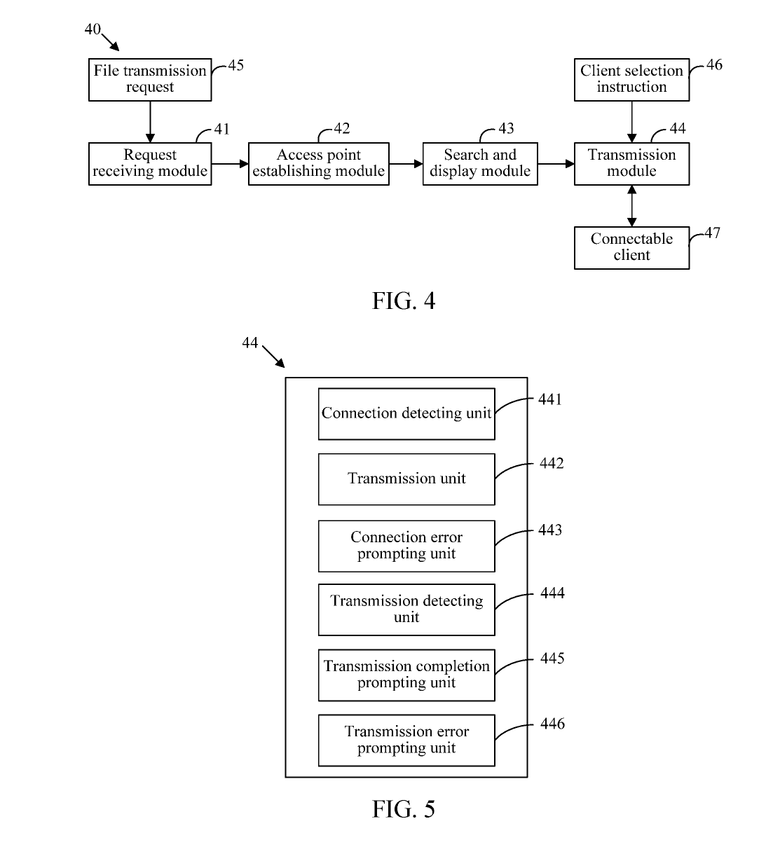

The present disclosure further provides a file transmission apparatus. Referring to FIG. 4, FIG. 4 illustrates a schematic structural diagram of a file transmission apparatus of some embodiments of the present disclosure. The file transmission apparatus 40 of this preferred embodiment can be configured to implement the file transmission method illustrated in FIG. 1. The file transmission apparatus 40 includes a request receiving module 41, an access point establishing module 42, a search and display module 43, and a transmission module 44. The request receiving module 41 is configured to receive a file transmission request 45 of an application; the access point establishing module 42 is configured to establish, in response to receiving the file transmission request 45, an access point for wireless access; the search and display module 43 is configured to search for a connectable client 47 by using the access point for wireless access and display the connectable client 47; and the transmission module 44 is configured to receive a client selection instruction 46, connect to a corresponding connectable client 47 according to the client selection instruction 46, and send a file.

When the file transmission apparatus 40 of this preferred embodiment is used, first the request receiving module 41 receives a file transmission request 45 of a third-party application, where the file transmission request 45 includes a position and a filename of a to-be-transmitted file. The third-party application is an application incapable of providing a short-distance file transmission function, and at the same time, the third-party application is capable of invoking a sharing interface of a mobile terminal to send the file transmission request 45 to another application (for example, a transmission application having a short-distance file transmission function) through the sharing interface. The file transmission request 45 may be a request for sending a to-be-transmitted file at a specific position and having a specific name to another mobile terminal or client. Therefore, the file transmission request 45 should include the position and the filename of the to-be-transmitted file.

Subsequently, the access point establishing module 42 establishes, according to the received file transmission request 45, an access point for wireless access. The access point for wireless access, that is, a wireless access point, is equivalent to a bridge for connecting different wireless network clients, and file transmission between different network clients can be implemented by using the access point for wireless access. A network client herein may be a mobile terminal connected to the access point for wireless access or may be a mobile terminal establishing the access point for wireless access.

Then, the search and display module 43 searches for a connectable client 47 (network client) by using the access point for wireless access and displays the connectable client 47. In order to implement short-distance transmission between different network clients, the search and display module 43 searches for a connectable client 47 by using the access point for wireless access. In this embodiment, the network client herein should have a wireless network (for example, WiFi) enabled, to ensure that the search and display module 43 can find a network client to which the file needs to be transmitted. After finding all connectable clients, the search and display module 43 displays all of the found connectable clients 47 in a list, so that a user makes a selection.

The transmission module 44 receives a client selection instruction 46, where the client selection instruction 46 is an instruction sent by the user for selecting a connectable client. In this way, the transmission module 44 connects to the selected connectable client 47 and sends a file having the filename and at the position to the selected connectable client 47 after the connection.

Preferably, when the file transmission apparatus 40 is set in a mobile terminal, the file transmission apparatus registers an action value in a system file of the mobile terminal to invoke a sharing interface of the mobile terminal, where code of the action value is:

<action android:name=“android.intent.action.SEND”/>; and

the file transmission apparatus 40 may receive file transmission requests 45 of different applications by invoking the sharing interface of the mobile terminal.

Preferably, referring to FIG. 5, FIG. 5 illustrates a schematic structural diagram of a transmission module of some embodiments of the present disclosure. The transmission module 44 of the file transmission apparatus 40 of this preferred embodiment includes a connection detecting unit 441, a transmission unit 442, a connection error prompting unit 443, a transmission detecting unit 444, a transmission completion prompting unit 445, and a transmission error prompting unit 446. The connection detecting unit 441 is configured to detect whether the corresponding connectable client 47 is connected; the transmission unit 442 is configured to send the to-be-transmitted file to the connectable client 47; the connection error prompting unit 443 is configured to prompt a connection error; the transmission detecting unit 444 is configured to detect whether the to-be-transmitted file is completely sent; the transmission completion prompting unit 445 is configured to prompt transmission completion; and the transmission error prompting unit 446 is configured to prompt a transmission error.

When the transmission module 44 works, first the transmission module 44 connects to the corresponding connectable client 47, and the connection detecting unit 441 of the transmission module 44 determines whether the transmission module 44 has connected to the corresponding connectable client 47. If the transmission module 44 has connected to the corresponding connectable client 47, the transmission unit 442 of the transmission module 44 sends the to-be-transmitted file to the connectable client 47. If the transmission module 44 is not connected to the corresponding connectable client 47, the transmission module 44 reconnects to the connectable client 47 or the connection error prompting unit 443 of the transmission module 44 prompts a connection error.

Subsequently, the transmission detecting unit 444 of the transmission module 44 determines whether the to-be-transmitted file is completely sent. The transmission completion prompting unit 445 of the transmission module 44 prompts transmission completion if the to-be-transmitted file is completely sent. The transmission module 44 re-sends the to-be-transmitted file or the transmission error prompting unit 446 of the transmission module 44 prompts a transmission error if sending of the to-be-transmitted file is interrupted.

In the file transmission apparatus of this preferred embodiment, an access point for wireless access is automatically established by using a transmission application and the access point for wireless access is automatically used to perform file transmission, so that a transmission process is not limited by an external network and has a high transmission speed.

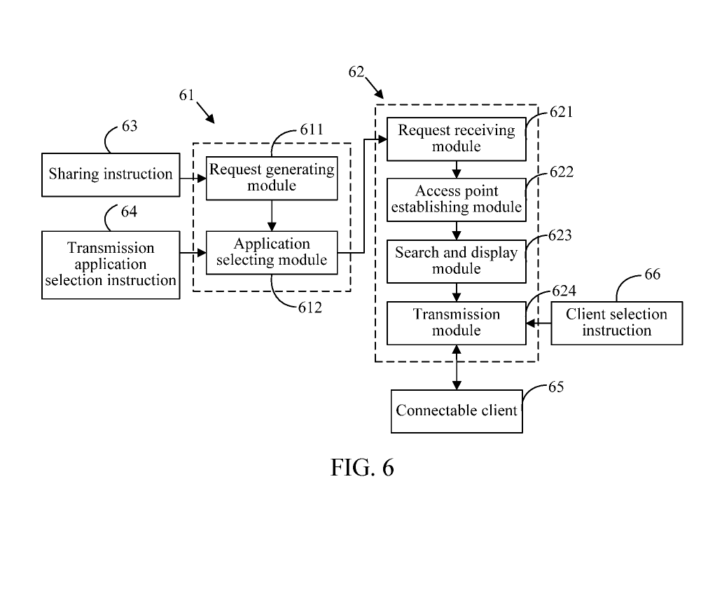

The present disclosure further provides a file transmission system. Referring to FIG. 6, FIG. 6 illustrates a schematic structural diagram of a file transmission system of some embodiments of the present disclosure. The file transmission system 60 of this preferred embodiment can be configured to implement the file transmission method illustrated in FIG. 3. The file transmission system 60 includes a first file transmission apparatus 61 and a second file transmission apparatus 62. The first file transmission apparatus 61 may be a requesting application set in a mobile terminal and the second file transmission apparatus 62 may be a transmission application set in a mobile terminal.

The first file transmission apparatus 61 includes a request generating module 611 and an application selecting module 612. The request generating module 611 is configured to receive a sharing instruction 63 and generate a file transmission request according to the sharing instruction 63, where the file transmission request includes a position and a name of a to-be-transmitted file. The application selecting module 612 is configured to receive a transmission application selection instruction 64 and determine a transmission application according to the transmission application selection instruction 64.

The second file transmission apparatus 62 includes a request receiving module 621, an access point establishing module 622, a search and display module 623, and a transmission module 624. The request receiving module 621 is configured to receive the file transmission request; the access point establishing module 622 is configured to establish, in response to receiving the file transmission request, an access point for wireless access; the search and display module 623 is configured to search for a connectable client 65 by using the access point for wireless access and display the connectable client 65; and the transmission module 624 is configured to receive a client selection instruction 66, connect to a corresponding connectable client 65 according to the client selection instruction 66, and send the to-be-transmitted file.

When the file transmission system 60 of this preferred embodiment is used, first the request generating module 611 of the first file transmission apparatus 61 in the mobile terminal receives a sharing instruction 63 input by a user and generates a file transmission request according to the sharing instruction 63, where the sharing instruction 63 is an instruction of requesting file transmission by the user. The file transmission request includes a position and a name of a to-be-transmitted file. The requesting application is an application incapable of providing a short-distance file transmission function and capable of invoking a sharing interface of the mobile terminal.

Subsequently, the application selecting module 612 of the first file transmission apparatus 61 invokes the sharing interface of the mobile terminal, and the requesting application may obtain at least one transmission application (the transmission application has a short-distance file transmission function) through the sharing interface of the mobile terminal. Subsequently, the application selecting module 612 receives a transmission application selection instruction 64 and determines, according to the transmission application selection instruction 64, a transmission application for transmitting the file. The transmission application selection instruction 64 is an instruction of selecting a transmission application by the user, for example, if the sharing interface of the mobile terminal provides three transmission applications, that is, “sharing by using WeChat (WeChat), sharing by using QQ (QQ), and sharing by using Mobile Manager (Mobile Manager)”, the user may select Mobile Manager as the transmission application.

Then the request receiving module 621 of the second file transmission apparatus 62 receives the file transmission request of the first file transmission apparatus 61, and the access point establishing module 622 of the second file transmission apparatus 62 establishes, in response to receiving the file transmission request, an access point for wireless access. The access point for wireless access, that is, a wireless access point, is equivalent to a bridge for connecting different wireless network clients, and file transmission between different network clients can be implemented by using the access point for wireless access. A network client herein may be a mobile terminal connected to the access point for wireless access or may be a mobile terminal establishing the access point for wireless access.

Subsequently, the search and display module 623 of the second file transmission apparatus 62 searches for a connectable client 65 (network client) by using the access point for wireless access and displays the connectable client 65. In order to implement short-distance transmission between different network clients, the search and display module 623 searches for a connectable network client by using the access point for wireless access, where the network client herein should have a wireless network (for example, WiFi) enabled, to ensure that the search and display module 623 can find a network client to which the file needs to be transmitted. After finding all connectable clients 65, the search and display module 623 displays all of the found connectable clients 65 in a list, so that the user makes a selection.

Finally, the transmission module 624 of the second file transmission apparatus 62 receives a client selection instruction 66, where the client selection instruction 66 is an instruction sent by the user for selecting a connectable client 65. In this way, the second file transmission apparatus 62 connects to the selected connectable client 65, and sends the to-be-transmitted file to the connectable client 65 after the connection.

Preferably, when the second file transmission apparatus 62 is set in a mobile terminal, the second file transmission apparatus 62 registers an action value in a system file of the mobile terminal to invoke a sharing interface of the mobile terminal, where code of the action value is:

<action android:name=“android.intent.action.SEND”/>; and

the second file transmission apparatus 62 may receive file transmission requests of different applications by invoking the sharing interface of the mobile terminal.

In the file transmission system of this preferred embodiment, a requesting application of a mobile terminal can invoke a transmission application through a sharing interface of the mobile terminal to automatically establish an access point for wireless access, and the transmission application can automatically use the access point for wireless access to perform file transmission, so that a transmission process is not limited by an external network and has a high transmission speed.

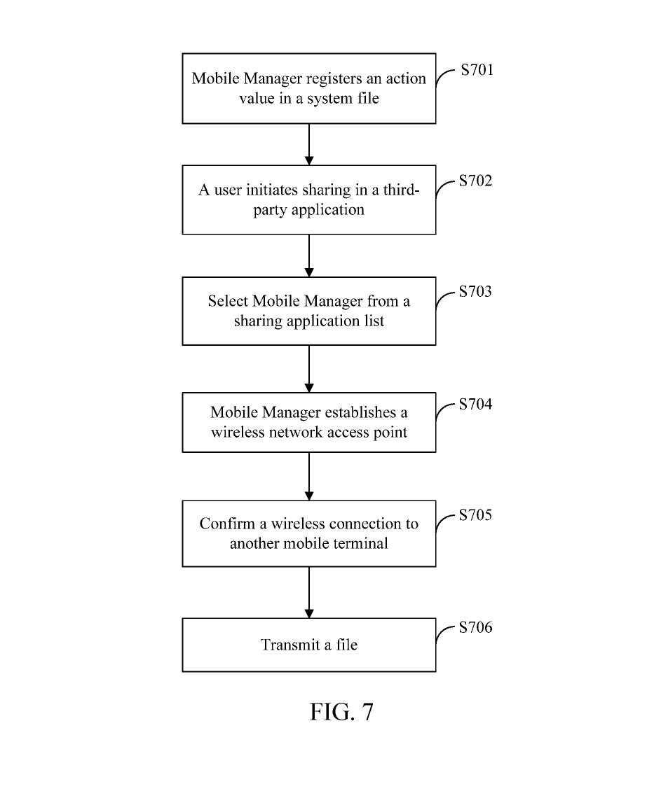

A working principle of the file transmission system of the present disclosure is described by using a specific embodiment. Referring to FIG. 7, FIG. 7 illustrates a working flowchart of a file transmission system in some embodiments of the present disclosure. In this embodiment, the second file transmission apparatus or transmission application is Mobile Manager, and the first file transmission apparatus or requesting application is a third-party application. The working process of the file transmission system includes:

Step S701: After being installed in a mobile terminal, Mobile Manager registers an action value in a system file of the mobile terminal, where Mobile Manager can be invoked for sharing when all third-party applications invoke a sharing interface of the mobile terminal, where code for technical implementation is:

<action android:name=“android.intent.action.SEND”/>.

Step S702: A user initiates sharing in a third-party application (for example, sharing a photo in a system photo album).

Step S703: The user selects Mobile Manager from multiple sharing approaches (for example, sharing by using WeChat, sharing by using Moments, sharing by using Microblog, and sharing by using Mobile Manager) to perform sharing.

Step S704: Mobile Manager establishes a wireless network access point to form a short-distance file transmission network, and searches for and connects to another mobile terminal having Mobile Manager installed and having a wireless network enabled in the network.

Step S705: A user of the another mobile terminal confirms the wireless connection, so that a short-distance transmission channel between the two mobile terminals is established.

Step S706: Transmit a file until completion.

In the file transmission method, file transmission apparatus, and file transmission system of the present invention, an access point for wireless access is automatically established by using a transmission application and the access point for wireless access is automatically used to perform file transmission, thereby solving a technical problem that an existing file transmission method, file transmission apparatus, and file transmission system are greatly limited by an external network or have a low transmission speed.

Functional units according to the embodiments of the present invention may be integrated in one processing module or exist as separate physical units, or two or more units are integrated in one module. The integrated modules may be implemented in the form of hardware or software functional modules. If implemented in the form of software functional modules and sold or used as an independent product, the integrated modules may also be stored in a computer-readable storage medium. The aforementioned storage medium may be a read-only memory, a magnetic disk or an optical disc. The foregoing apparatuses or systems can execute methods in corresponding method embodiments.

To sum up, the present disclosure has been disclosed through preferred embodiments; however, the preferred embodiments are not intended to limit the present disclosure, and a person of ordinary skill in the art can make various modifications and improvements without departing from the spirit and scope of the present disclosure; therefore, the protection scope of the present disclosure should be subject to the scope defined by the claims.

What is claimed is:

1. A file transmission method, applied to an electronic device, which comprises a memory, at least one processor in communication with the memory, and program instructions stored in the memory and executed by the at least one processor, the method comprising:
receiving by the electronic device a file transmission request from an application, the file transmission request comprising a position and a filename of a to-be-transmitted file from the application;
establishing by the electronic device, in response to receiving the file transmission request, a wireless access point;
searching by the electronic device for at least one connectable client by using the wireless access point;
displaying the at least one connectable client in a form of a list;
receiving by the electronic device a selection instruction for a connectable client in the list; and
establishing by the electronic device a connection to the connectable client corresponding to the selection instruction and sending the to-be-transmitted file having the filename and at the position to the selected connectable client.

2. The method according to claim 1, comprising:
receiving by the electronic device the file transmission request from the application through utilizing a sharing interface of the electronic device.

3. The method according to claim 2, wherein the electronic device comprises a sharing interface and receives the file transmission request from the application by utilizing the sharing interface of the electronic device, comprises:
registering by the electronic device an action value in a system file of the electronic device to utilize the sharing interface of the electronic device.

4. The method according to claim 1, wherein the electronic device establishes a connection to the connectable client corresponding to the selection instruction and sends the to-be-transmitted file having the filename and at the position to the selected connectable client, comprises:
detecting whether the connectable client corresponding to the selection instruction is connected; and
sending, if the connectable client corresponding to the selection instruction is connected, the file having the filename and at the position to the connectable client; or
re-establishing, if the connectable client corresponding to the selection instruction is not connected, a connection to the connectable client.

5. The method according to claim 4, wherein the electronic device sends the to-be-transmitted file having the filename and at the position to the selected connectable client, further comprising:
detecting whether the to-be-submitted file is completely sent; and
prompting, if the file is completely sent, a transmission completion; or
re-sending the file if sending of the file is interrupted.

6. The method according to claim 4, wherein the electronic device sends the to-be-transmitted file having the filename and at the position to the selected connectable client, further comprising:
detecting whether the to-be-submitted file is completely sent; and
prompting, if the file is completely sent, a transmission completion; or
prompting a transmission error if sending of the file is interrupted.

7. The method according to claim 1, wherein the electronic device establishes a connection to the connectable client corresponding to the selection instruction and sends the to-be-transmitted file having the filename and at the position to the selected connectable client, comprises:
detecting whether the connectable client corresponding to the selection instruction is connected; and
sending, if the connectable client corresponding to the selection instruction is connected, the file having the filename and at the position to the connectable client; or
prompting, if the connectable client corresponding to the selection instruction is not connected, a connection error.

8. The method according to claim 7, wherein the electronic device sends the to-be-transmitted file having the filename and at the position to the selected connectable client, further comprising:
detecting whether the to-be-submitted file is completely sent; and
prompting, if the file is completely sent, a transmission completion; or
re-sending the file if sending of the file is interrupted.

9. The method according to claim 7, wherein the electronic device sends the to-be-transmitted file having the filename and at the position to the selected connectable client, further comprising:
detecting whether the to-be-submitted file is completely sent; and
prompting, if the file is completely sent, a transmission completion; or
prompting a transmission error if sending of the file is interrupted.

10. A file transmission apparatus, comprising:
a memory containing program instructions; and
at least one processor, in communication with the memory, when executing the program instructions, is configured to cause the apparatus to:
receive a file transmission request from an application, the file transmission request comprising a position and a filename of a to-be-transmitted file;
establish, in response to receiving the file transmission request, a wireless access point;
search for at least one connectable client by using the wireless access point and display the at least one connectable client in a form of a list; and
receive a selection instruction for a connectable client in the list, establish a connection to the connectable client corresponding to the selection instruction, and send the to-be-transmitted file having the filename and at the position to the selected connectable client.

11. The apparatus according to claim 10, wherein the at least one processor, when executing the program instructions to cause the apparatus to receive the file transmission request, is configured to cause the apparatus to receive the file transmission request from the application by utilizing a sharing interface of the apparatus.

12. The apparatus according to claim 11, wherein the at least one processor, when executing the program instructions to cause the apparatus to receive the file transmission request, is configured to cause the apparatus to register an action value in a system file of the apparatus to use the sharing interface of the apparatus.

13. The apparatus according to claim 10, wherein the at least one processor, when executing the program instructions to cause the apparatus to send the to-be-transmitted file having the filename and at the position to the selected connectable client, is configured to cause the apparatus to:
detect whether the connectable client corresponding to the selection instruction is connected; and
send, if the connectable client corresponding to the selection instruction is connected, the to-be-transmitted file having the filename and at the position to the selected connectable client; or
reconnect, if the connectable client corresponding to the selection instruction is not connected, the selected connectable client.

14. The apparatus according to claim 13, wherein at least one processor, when executing the program instructions to cause the apparatus to send the to-be-transmitted file having the filename and at the position to the selected connectable client, is further configured to cause the apparatus to:
detect whether the to-be-transmitted file is completely sent; and
prompt, if the to-be-transmitted file is completely sent, a transmission completion; or
re-send, if the to-be-transmitted file is not completely sent, the to-be-transmitted file to the selected connectable client.

15. The apparatus according to claim 13, wherein at least one processor, when executing the program instructions to cause the apparatus to send the to-be-transmitted file having the filename and at the position to the selected connectable client, is further configured to cause the apparatus to:
detect whether the to-be-transmitted file is completely sent; and
prompt, if the to-be-transmitted file is completely sent, a transmission completion; or
prompt, if the to-be-transmitted file is not completely sent, a transmission error.

16. The apparatus according to claim 10, wherein the at least one processor, when executing the program instructions to cause the apparatus to send the to-be-transmitted file having the filename and at the position to the selected connectable client, is configured to cause the apparatus to:
detect whether the connectable client corresponding to the selection instruction is connected; and
send, if the connectable client corresponding to the selection instruction is connected, the to-be-transmitted file having the filename and at the position to the selected connectable client; or
prompt, if the connectable client corresponding to the selection instruction is not connected, a connection error.

17. The apparatus according to claim 16, wherein at least one processor, when executing the program instructions to cause the apparatus to send the to-be-transmitted file having the filename and at the position to the selected connectable client, is further configured to cause the apparatus to:
detect whether the to-be-transmitted file is completely sent; and
prompt, if the to-be-transmitted file is completely sent, a transmission completion; or
re-send, if the to-be-transmitted file is not completely sent, the to-be-transmitted file to the selected connectable client.

18. The apparatus according to claim 16, wherein at least one processor, when executing the program instructions to cause the apparatus to send the to-be-transmitted file having the filename and at the position to the selected connectable client, is further configured to cause the apparatus to:
detect whether the to-be-transmitted file is completely sent; and
prompt, if the to-be-transmitted file is completely sent, a transmission completion; or
prompt, if the to-be-transmitted file is not completely sent, a transmission error.

19. A file transmission system, comprising:
a first file transmission apparatus, comprising:
a first memory containing a first set of program instructions;
at least one first processor, in communication with the first memory, when executing the first set of program instructions, is configured to cause the first apparatus to:
receive a sharing instruction and generate, in response to receiving the sharing instruction, a file transmission request comprising a position and a filename of a to-be-transmitted file; and
receive a transmission application selection instruction and determine a transmission application according to the transmission application selection instruction; and
a second file transmission apparatus, comprising:
a second memory containing a second set of program instructions;
at least one second processor, in communication with the second memory, when executing the second set of program instructions, is configured to cause the second apparatus to:
receive the file transmission request from the first apparatus;
establish, in response to receiving the file transmission request, a wireless access point;
search for at least one connectable client by using the wireless access point and display the at least one connectable client in a form of a list; and
receive a selection instruction for a connectable client in the list, establish a connection to the connectable client corresponding to the selection instruction, and send the to-be-transmitted file having the filename and at the position to the selected connectable client.

20. The system according to claim 19, wherein the at least one second processor in the second file transmission apparatus is configured to cause the second apparatus to receive the file transmission request of the application by using a sharing interface of the second file transmission apparatus.

21. The system according to claim 20, wherein the second file transmission apparatus registers an action value in a system file of the second file transmission apparatus to use the sharing interface of the second file transmission apparatus.
